(19) United States
(12) Patent Application Publication
(10) Pub. No.: US 2026/0280400 A1
(43) Pub. Date: Sep. 17, 2026

(54) Magnetic energy controlled power generating system

(71) Applicant: TE-SHUI PU, Taichung City (TW)

(72) Inventor: TE-SHUI PU, Taichung City (TW)

(21) Appl. No.: 19/565,506

(22) Filed: Mar. 12, 2026

(30) Foreign Application Priority Data
Mar. 13, 2025 (TW) 114109392

(51) Int. Cl. H02K 51/00; H02K 7/075; H02K 11/00; H02K 11/04

(52) U.S. Cl. CPC H02K 51/00; H02K 7/075; H02K 11/0094; H02K 11/04

(57) ABSTRACT

A magnetic energy control power generation system includes: a base having a magnet control unit, three energy storage devices, three controllers, and a crankshaft. The crankshaft is connected to a generator and a drive motor. The magnet control unit has three standing pipes fixed to the base, each containing a magnetic core with an electromagnetic coil wound around it. When the electromagnetic coil is energized, the magnetic pole direction changes, allowing the magnetic core to be extended upwards or retracted after being extended upwards. The crankshaft is horizontally pivoted on the base and has three connecting rods connected to it. The three connecting rods are pivotally connected to the three magnetic cores, allowing the crankshaft to rotate via the extension or retraction of the magnetic cores.

### BACKGROUND OF THE INVENTION

### Field of the Invention

The present invention relates to a magnetic energy-controlled power generating system.

### Description of the Related Art

Currently known generators, typically have a base frame 12 fixed to the bottom of the main body 1, and a base shaft 11 is mounted on the base frame 12, allowing the shaft to rotate. A booster cylinder 10 is fixed to the base shaft 11, and a connector 4 is mounted at the top of the booster cylinder's telescopic rod 3, connecting to a crankshaft 5. Both ends of the crankshaft 5 are mounted above the main body 1, and one of the end of the crankshaft 5 is fixed with a gear and connected to a gear set 6. Power is transmitted to the generator 7 through the transmission and speed change of the gear set 6, and a hydraulic pump 2 is installed outside the main body 1 and is connected to the booster cylinder 10 via a pipeline 8.

In use, the booster cylinder's telescopic rod 3 drives the connector 4 to move up and down to drive the shaft to rotates, and the crankshaft 5 transmits power to the generator 7 via the gear set 6.

Furthermore, the crankshaft 5 is divided into two groups: ab is the first group, and cd is the second group. When the first group starts working at 45 degrees, a reaches 135 degrees and b reaches 315 degrees and stops. At this time, d reaches 45 degrees and c reaches 225 degrees, simultaneously starting to work. d then reaches 135 degrees and c reaches 315 degrees, and the two groups alternate.

However, the above-mentioned conventional structure still has the following problems in practical applications: using the booster cylinder 10 to hydraulically drive the booster cylinder telescopic rod 3 for the telescopic system is energy-intensive, resulting in poor power generation efficiency for the generator.

Therefore, it is desirable to provide a magnetic energy-controlled power generating system to mitigate and/or obviate the aforementioned problems.

### SUMMARY OF THE INVENTION

An objective of present invention is to provide a magnetic energy-controlled power generating system, which is capable of improving the above-mention problems.

In order to achieve the above-mentioned objective, a magnetic energy-controlled power generating system has a base having a magnet control unit, at least three energy storage devices, at least three controllers, and a crankshaft interconnected with a generator and a drive motor.

The magnet control unit has at least three standing pipes fixed to the base, and each standing pipe has a magnetic core wound with an electromagnetic coil; by energizing the electromagnetic coil, a magnetic pole direction is changed, allowing the magnetic core to be pushed upwards or retracted after being pushed; and the electromagnetic coil of each standing pipe is connected to an energy storage device.

Each energy storage device comprises at least one battery to store electricity generated by the power generation, each of the energy storage devices is individually controlled by a controller, and each energy storage device has a rectifier and is connected to the drive motor through an inverter, a frequency converter.

The crankshaft is horizontally pivoted on the base, at least three connecting rods are connected to the crankshaft, and each of the connecting rods is pivoted to one of the magnetic cores; extension or retraction of the magnetic cores drives the crankshaft's rotation via the connecting rods; the crankshaft also comprises at least three cams, each of the cams is spaced at a predetermined angle to respectively correspond to one of the connecting rods and one of the magnetic cores, each of the cams has two angle sensors; when the crankshaft rotates due to the connecting rods and magnetic cores, the angle sensors detect when the connecting rods have reached a maximum or minimum travel position, the angle signals are then transmitted to the controller to change the magnetic poles of the electromagnetic coils, and a weight of the cams themselves generates inertial acceleration as they rotate downwards, reducing the crankshaft's rotation speed; and the generator is connected to the rectifier of the energy storage device via a transformer.

### BRIEF DESCRIPTION OF THE DRAWINGS

FIG. 1 is a block diagram of a preferred embodiment of the present invention.

FIG. 2 is a perspective view of the preferred embodiment of the present invention.

FIG. 3 is a partially exploded view of the preferred embodiment of the present invention.

FIG. 4 is a plan view of the preferred embodiment of the present invention.

FIG. 5 is a plan view from another angle of the preferred embodiment of the present invention.

FIG. 6 is a status drawing showing using the extension of the magnetic core to push the connecting rod according to the preferred embodiment of the present invention.

FIG. 7 is a status drawing showing the magnetic core fully extended according to the preferred embodiment of the present invention.

FIG. 8 is a status drawing showing the crankshaft being rotated according to the preferred embodiment of the present invention.

FIG. 9 is a status drawing showing the retraction of the magnetic core according to the preferred embodiment of the present invention.

### DETAILED DESCRIPTION OF PREFERRED EMBODIMENT

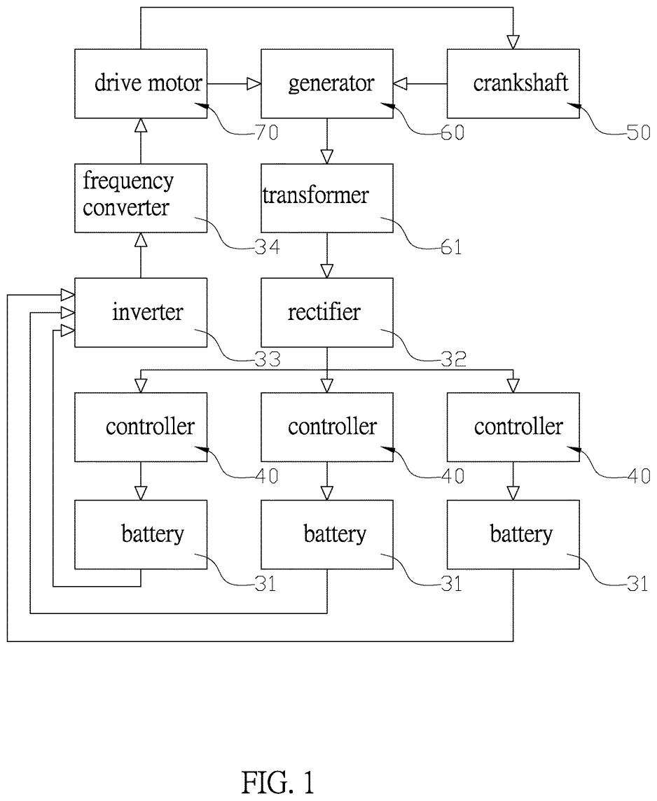

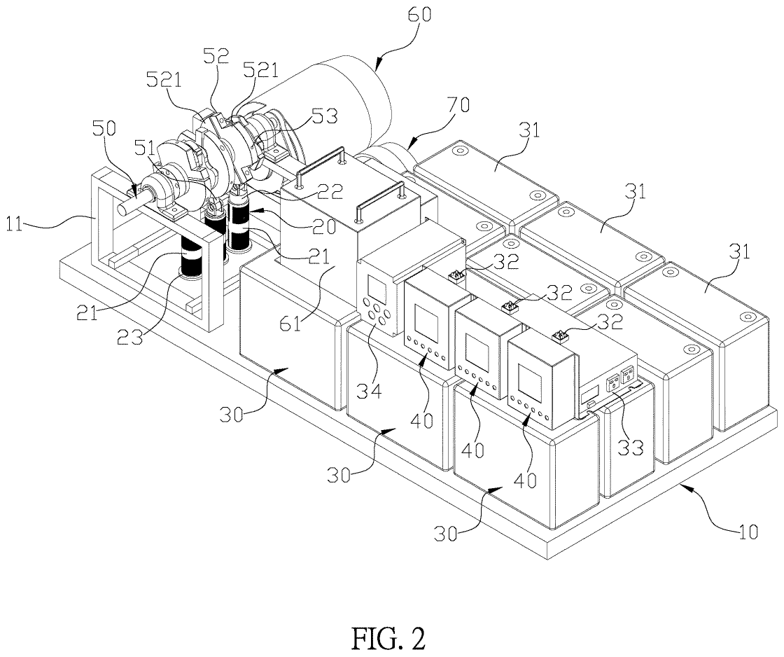

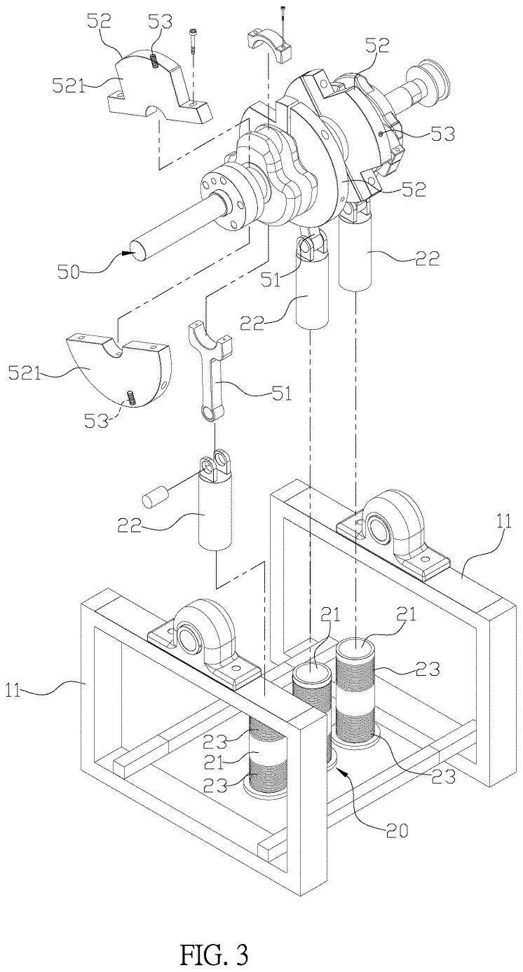

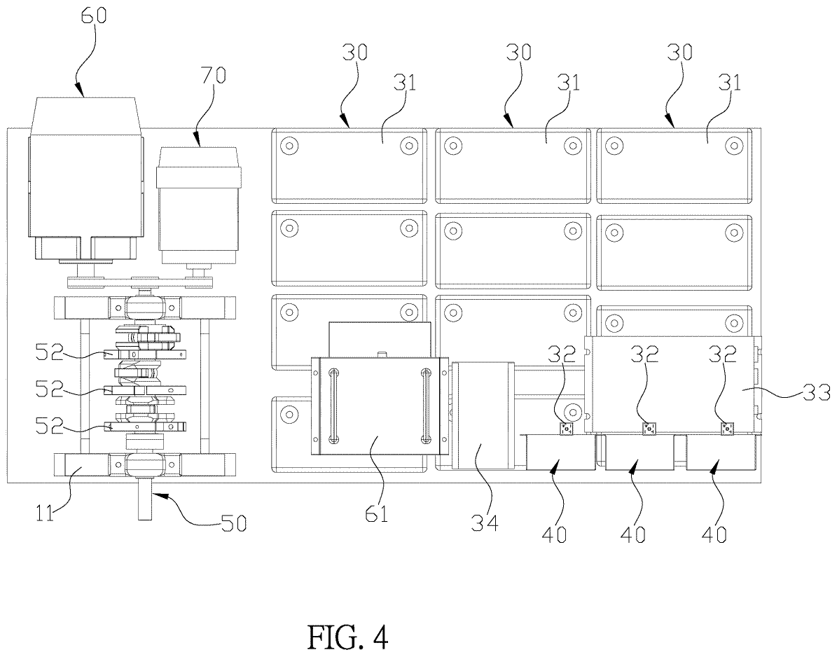

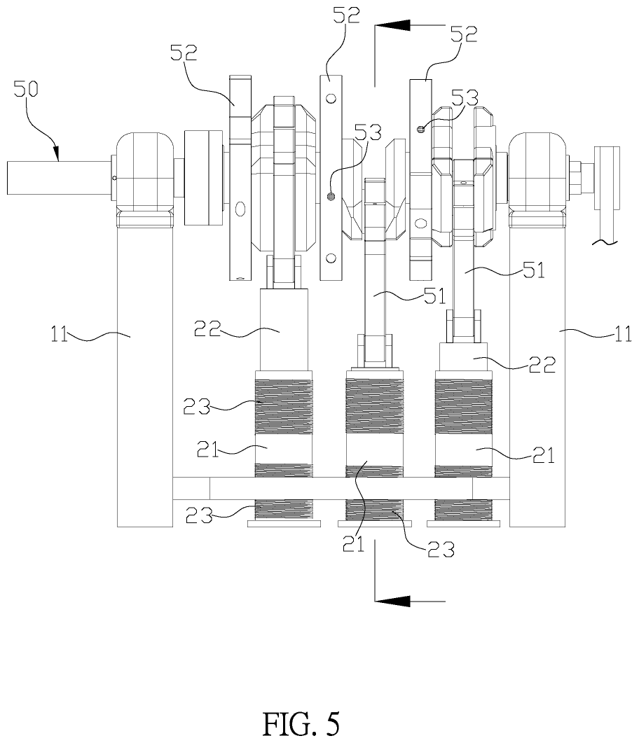

First, please refer to FIGS. 1 to 5. A magnetic energy-controlled power generating system comprises: a base 10 having magnet control unit 20, three energy storage devices 30, three controllers 40 and a crankshaft 50 interconnected with a generator 60 and a drive motor 70. The magnet control unit 20 has three standing pipes 21 fixed to the base 10 in a straight line, and each standing pipe 21 has a magnetic core 22 wound with the electromagnetic coil 23. By energizing the electromagnetic coil 23, the magnetic pole direction is changed, allowing the magnetic core 22 to be pushed upwards or retracted after being pushed for power generation, and the electromagnetic coil of each standing pipe's is connected to an energy storage device 30. The energy storage device 30 comprises at least one battery 31 to store electricity generated by the power generation, each of the energy storage devices 30 is individually controlled by a controller 40, and each energy storage device 30 has a rectifier 32 and is connected to the drive motor 70 through an inverter 33 and a frequency converter 34. The crankshaft 50 is horizontally pivoted on the base 10, three connecting rods 51 are connected to the crankshaft 50, and each of the connecting rods 51 is pivoted to one of the magnetic cores 22. Extension or retraction of the magnetic cores 22 drives the rotation of the crankshaft 50 via the connecting rods 51. The crankshaft 50 also comprises three cams 52, each of the cams 52 is spaced at a predetermined angle to respectively correspond to one of the connecting rods 51 and one of the magnetic cores 22, each of the cams 52 has two angle sensors 53. When the crankshaft 50 rotates due to the connecting rods 51 and magnetic cores 22, the angle sensors 53 detect when the connecting rods 51 have reached a maximum or minimum travel position, the angle signals are then transmitted to the controller 50 to change the magnetic poles of the electromagnetic coils 23, and a weight of the cams 52 themselves generates inertial acceleration as they rotate downwards, reducing the crankshaft 50's rotation speed, and the generator is connected to the rectifier 32 of the energy storage device 20 via a transformer 61.

Moreover, the base 10 further has two support frames 11 configured for pivoting of the crankshafts 50.

Also, each cam 52 comprises two cam blocks 521; by connecting the two cam blocks 521, the cam 52 can be clamped onto the crankshaft 50, and the two angle sensors 53 of each cam 52 are respectively installed on the two cam blocks 521.

Furthermore, each angle sensor 53 transmits the measured signal to a controller 40 wirelessly such as Wi-Fi.

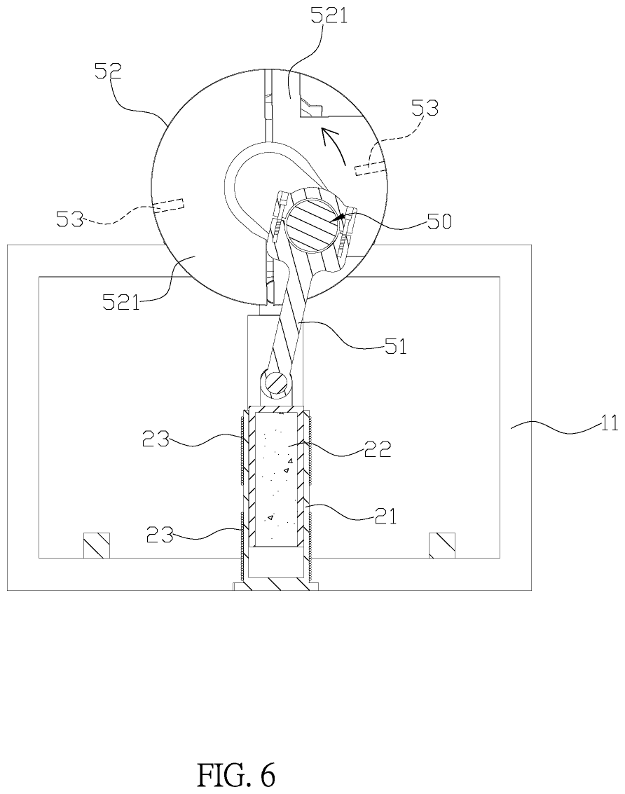

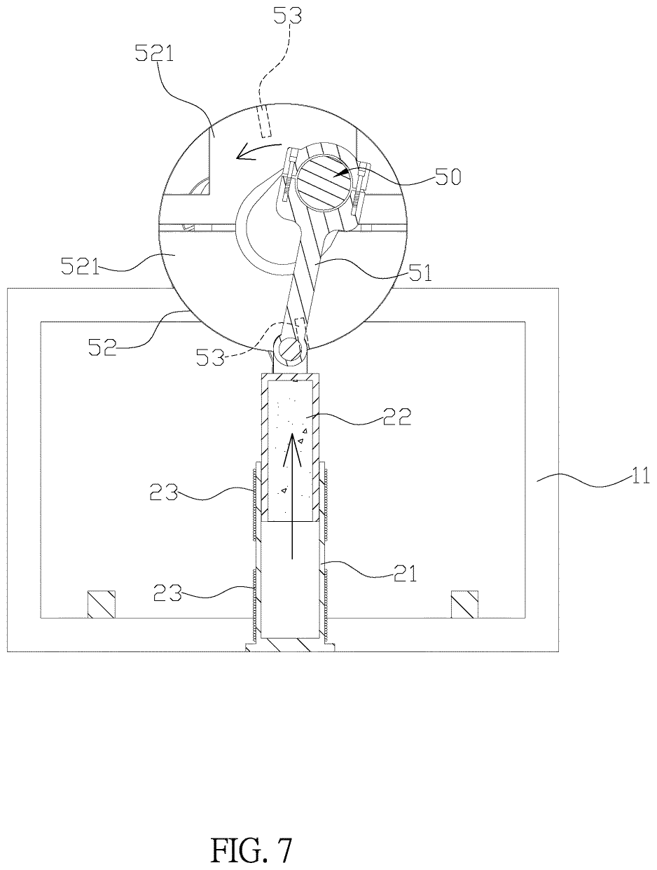

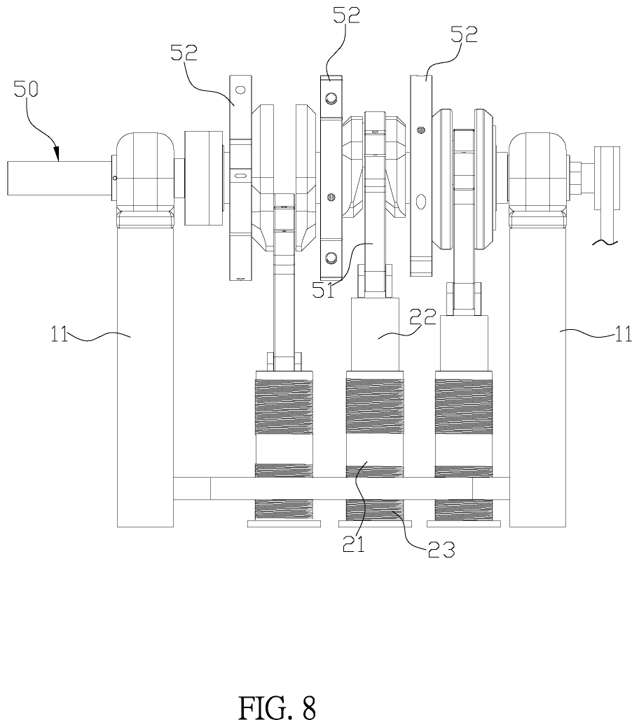

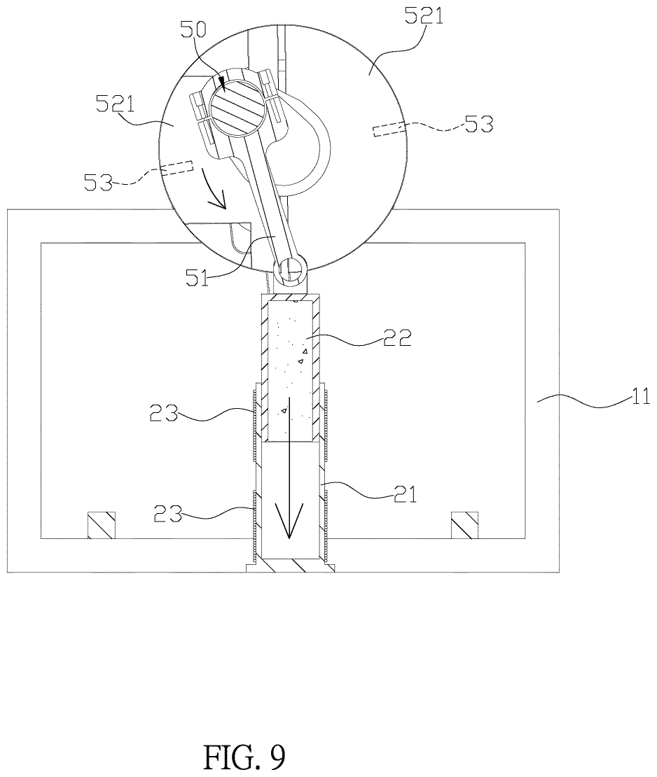

As described above, the three magnetic cores 22 drive the crankshaft 50 to rotate via the three connecting rods 51, and each connecting rod 51 rotates the crankshaft 50 by 120 degrees. The angle sensor 53 detects the rotation angle, and when the connecting rods 51 and the magnetic cores 22 reach a lowest stroke position (or the “bottom dead center”), the controller 40 changes the magnetic poles of the electromagnetic coils 23, allowing the magnetic cores 22 to be pushed upwards. (See FIGS. 6, 7, and 8). Conversely, when the connecting rods 51 reach a highest stroke position (top dead center), the controller 40 changes the magnetic poles of the electromagnetic coils 23 again, allowing the magnetic cores 22 to be retracted downwards. (See FIG. 9). This repeated operation ensures the crankshaft 50 rotates continuously, generating electricity. This electricity is then transmitted through the transformer 61 and the rectifier 32, the generated electricity, after deducting necessary energy consumption (i.e., the power consumed by the drive motor 70 and the electromagnetic coil 23 during normal operation), can be stored in the battery 31 of the energy storage device 30. During peak hours, the stored electricity is fed into the power grid through the inverter 33 and the frequency converter 34, thus achieving a magnetic energy control system that combines power generation and energy storage.

The magnetic energy control power generation system described above has the following advantages: It utilizes the change of the magnetic poles of the electromagnetic coil 23 to drive the crankshaft 50 to rotate via the magnetic core 22 and the connecting rod 51, resulting in low power generation energy consumption. Furthermore, the weight of the cam 52 itself generates inertial acceleration during downward rotation, making it easier to drive the crankshaft 50 to rotate upwards, thereby significantly improving power generation efficiency.

Although the present invention has been explained in relation to its preferred embodiment, it is to be understood that many other possible modifications and variations can be made without departing from the spirit and scope of invention as hereinafter claimed.

What is claimed is:

1. A magnetic energy-controlled power generating system comprising: a base having a magnet control unit, at least three energy storage devices, at least three controllers, and a crankshaft interconnected with a generator and a drive motor; wherein:
the magnet control unit has at least three standing pipes fixed to the base, and each standing pipe has a magnetic core wound with an electromagnetic coil; by energizing the electromagnetic coil, a magnetic pole direction is changed, allowing the magnetic core to be pushed upwards or retracted after being pushed; and the electromagnetic coil of each standing pipe is connected to an energy storage device;
each energy storage device comprises at least one battery to store electricity generated by the power generation, each of the energy storage devices is individually controlled by a controller, and each energy storage device has a rectifier and is connected to the drive motor through an inverter, a frequency converter; and
the crankshaft is horizontally pivoted on the base, at least three connecting rods are connected to the crankshaft, and each of the connecting rods is pivoted to one of the magnetic cores; extension or retraction of the magnetic cores drives the crankshaft's rotation via the connecting rods; the crankshaft also comprises at least three cams, each of the cams is spaced at a predetermined angle to respectively correspond to one of the connecting rods and one of the magnetic cores, each of the cams has two angle sensors; when the crankshaft rotates due to the connecting rods and magnetic cores, the angle sensors detect when the connecting rods have reached a maximum or minimum travel position, the angle signals are then transmitted to the controller to change the magnetic poles of the electromagnetic coils, and a weight of the cams themselves generates inertial acceleration as they rotate downwards, reducing the crankshaft's rotation speed; and the generator is connected to the rectifier of the energy storage device via a transformer.

2. The magnetic energy-controlled power generating system as claimed in claim 1, wherein the base further has two support frames configured for pivoting of the crankshafts.

3. The magnetic energy-controlled power generating system as claimed in claim 1, wherein each cam comprises two cam blocks; by connecting the two cam blocks, the cam can be clamped onto the crankshaft, and the two angle sensors of each cam are respectively installed on the two cam blocks.

4. The magnetic energy-controlled power generating system as claimed in claim 1, wherein each angle sensor transmits the measured signal to a controller wirelessly.
